(19) United States
(12) Patent Application Publication
(10) Pub. No.: US 2010/0180267 A1
(43) Pub. Date: Jul. 15, 2010

(54) PLC COMPILING SYSTEM AND COMPILING METHOD

(75) Inventors: SHIH-HAO HUANG, Tu-Cheng (TW); FEI-HSU CHEN, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: FOXNUM TECHNOLOGY CO., LTD., Tucheng City (TW)

(21) Appl. No.: 12/412,387

(22) Filed: Mar. 27, 2009

(30) Foreign Application Priority Data
Jan. 12, 2009 (CN) 200910300144.8

(51) Int. Cl. G06F 9/45; G05B 19/42

(52) U.S. Cl. 717/140; 700/86

(57) ABSTRACT

A programmable logic controller (PLC) compiling system includes a ladder diagram loading unit, an instruction set loading unit storing instruction sets, an instruction compiling unit, an operating system loading unit storing dynamic link library (DLL) file templates based on a number of operating systems, and a DLL file compiling unit. The ladder diagram loading unit loads and stores predetermined ladder diagrams. The instruction compiling unit loads the predetermined ladder diagrams and the instruction sets, and compiles the predetermined ladder diagrams to a plurality of instructions corresponding to the instruction sets accordingly. The DLL file compiling unit loads the compiled instructions and the DLL file templates, and compiles the compiled instructions to a plurality of DLL files based on the DLL file templates to match the instruction sets accordingly.

### BACKGROUND

1. Technical Field

The present disclosure relates to compiling systems and, particularly, to a programmable logic controller (PLC) compiling system and a compiling method.

2. Description of Related Art

A PLC is a digital computer used for automation of electromechanical processes, such as control of machinery for factory assembly lines, amusement rides, or lighting apparatuses. Generally speaking, system programs of the PLC are initialized before leaving factory, with final compilation of application programs for the PLC performed onsite according to need, such as integration of application programs in an existing system, and matching the application programs with other instruction sets. However, if the application programs need to be applied to varying operating systems or hardware instruction sets, code of the application programs must be preloaded with compatibility for the entire possible range of environments, a complicated and high-maintenance undertaking.

### BRIEF DESCRIPTION OF THE DRAWINGS

FIG. 1 is a block diagram of an exemplary embodiment of a PLC compiling system.

FIG. 2 is a flowchart of an exemplary embodiment of a PLC compiling method.

FIG. 3 is a process diagram showing compilation of dynamic link library (DLL) files of FIG. 2.

### DETAILED DESCRIPTION

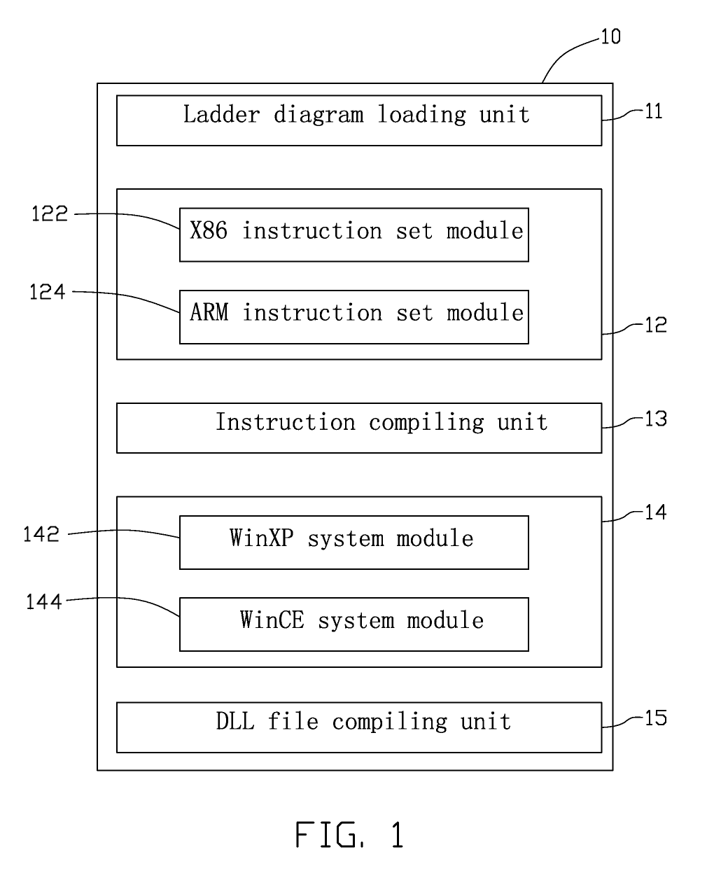

Referring to FIG. 1, an exemplary embodiment of a programmable logic controller (PLC) compiling system 10 includes a compiler. The compiler includes a ladder diagram loading unit 11, an instruction set loading unit 12, an instruction compiling unit 13, an operating system loading unit 14, and a dynamic link library (DLL) file compiling unit 15.

The ladder diagram loading unit 11 loads and stores predetermined ladder diagrams, namely, programming diagrams of electrical logic schematics, for easy compiling of programs of PLCs.

The instruction set loading unit 12 includes an X86 instruction set module 122 and an advanced Reduced Instruction Set Computer (RISC) machines (ARM) instruction set module 124 The X86 instruction set module 122 stores an X86 instruction set. The ARM instruction set module 124 stores an ARM instruction set. Alternatively, the instruction set loading unit 12 can further include other instruction sets according to need.

The instruction compiling unit 13 loads the predetermined ladder diagrams, the X86 instruction set, and the ARM instruction set, and compiles the predetermined ladder diagrams to X86 instructions based on the X86 instruction set and the ladder diagrams to ARM instructions based on the ARM instruction set.

The operating system loading unit 14 includes a Windows XP (WinXP) system module 142 and a Windows CE (WinCE) system module 144. The WinXP system module 142 stores a WinXP DLL file template based on a WinXP system. The WinCE system module 144 stores a WinCE DLL file template based on a WinCE system. The two kinds of DLL file templates are used to compile DLL files based on the corresponding operating systems. Alternatively, the operating system loading unit 14 can further include other DLL file templates corresponding to other operating systems according to need.

The DLL file compiling unit 15 loads the compiled X86 instructions, the compiled ARM instructions, and the DLL file templates based on the WinXP system and the WinCE system. The DLL file compiling unit 15 also configured for compiling the X86 instructions to WinXP system DLL files based on the WinXP DLL file template to match the X86 instruction set, configured for compiling the X86 instructions to WinCE system DLL files based on the WinCE DLL file template to match the X86 instruction set, configured for compiling the ARM instructions to WinXP system DLL files based on the WinXP DLL file template to match the ARM instruction set, and compiling the ARM instructions to WinCE system DLL files based on the WinCE DLL file template to match the ARM instruction set.

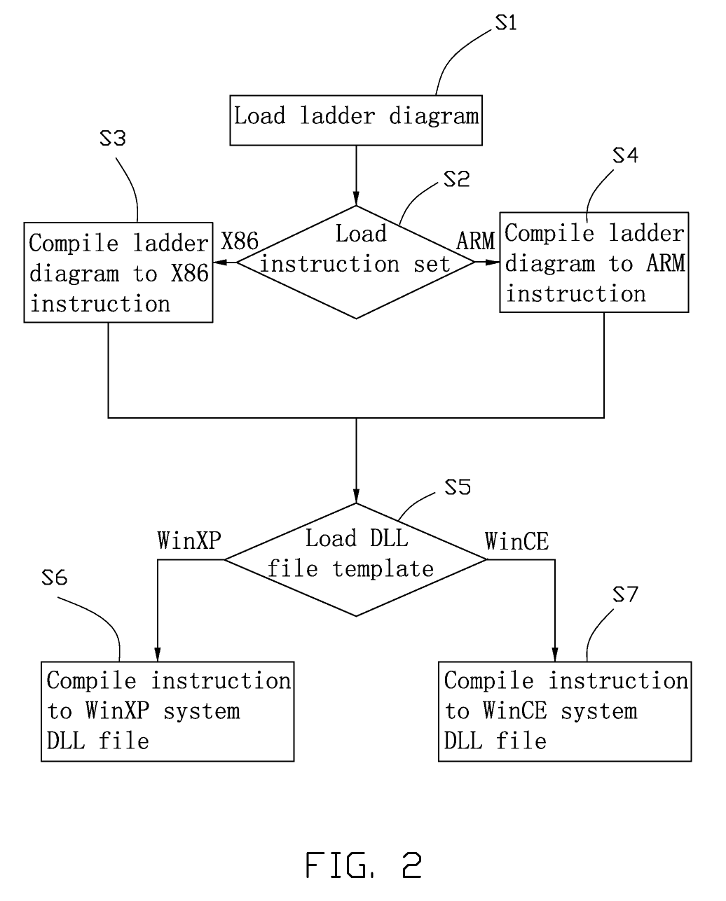

Referring to FIG. 2, an exemplary embodiment of a PLC compiling method includes the following steps.

In step S1, the ladder diagram loading unit 11 loads the predetermined ladder diagrams and stores the ladder diagrams.

In step S2, the instruction compiling unit 13 loads the ladder diagrams stored in the ladder diagram loading unit 11, and loads the X86 instruction set and the ARM instruction set stored in the instruction set loading unit 12.

In step S3, the instruction compiling unit 13 compiles the ladder diagrams to X86 instructions based on the X86 instruction set.

In step S4, the instruction compiling unit 13 compiles the ladder diagrams to ARM instructions based on the ARM instruction set.

In step S5, the DLL file compiling unit 15 loads the compiled X86 instructions, the compiled ARM instructions, and the DLL file templates based on the WinXP system and the WinCE system stored in the operating system loading unit 14.

In step S6, the DLL file compiling unit 15 compiles the X86 instructions to WinXP system DLL files based on the WinXP DLL file template to match the X86 instruction set, and compiles the ARM instructions to WinXP system DLL files based on the WinXP DLL file template to match the ARM instruction set.

In step S7, the DLL file compiling unit 15 compiles the X86 instructions to WinCE system DLL files based on the WinCE DLL file template to match the X86 instruction set, and compiles the ARM instructions to WinCE system DLL files based on the WinCE DLL file template to match the ARM instruction set.

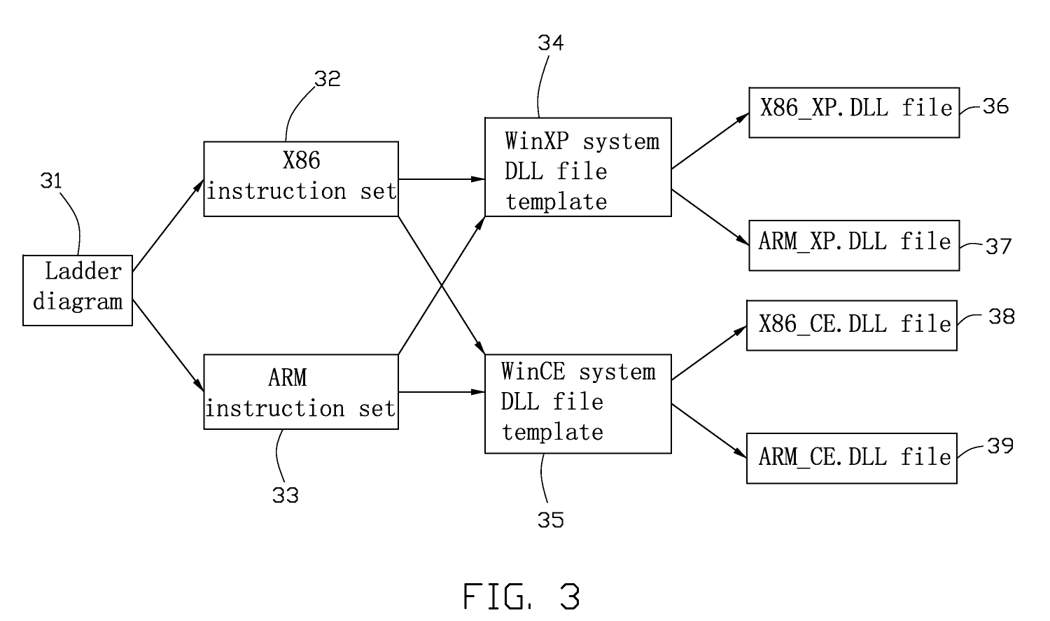

Referring to FIG. 3, PLC compiling begins with loading of the ladder diagrams 31, followed by loading of the X86 instruction set 32 and the ARM instruction set 33 to compile the ladder diagrams to X86 instructions and ARM instructions, and loading the WinXP system DLL file template 34 and the WinCE system DLL file template 34 to compile the X86 instructions and the ARM instructions to four kinds of DLL files, a X86_XP.DLL file 36 used in the WinXP system and matching the X86 instruction set, an ARM_XP.DLL file 37 used in the WinXP system and matching the ARM instruction set, an X86_CE.DLL file 38 used in WinCE system and matching the X86 instruction set, and an ARM_CE.DLL file 39 used in the WinCE system and matching the ARM instruction set.

The PLC compiling system 10 and PLC compiling method can compile many kinds of DLL files, compatible for application with a plurality of operating systems and matching many kinds of instruction sets in one compiling process.

It is to be understood, however, that even though numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A programmable logic controller (PLC) compiling system, comprising:
a ladder diagram loading unit configured for loading and storing predetermined ladder diagrams;
an instruction set loading unit configured for storing at least one instruction set;
an instruction compiling unit configured for loading the predetermined ladder diagrams from the ladder diagram loading unit and the at least one instruction set from the instruction set loading unit, and compiling the predetermined ladder diagrams into at least one instruction corresponding to the at least one instruction set;
an operating system loading unit configured for storing at least one dynamic link library (DLL) file template based on at least one operating system; and
a DLL file compiling unit configured for loading the compiled at least one instruction and the DLL file templates, and compiling the compiled at least one instruction into corresponding of DLL files based on the at least one DLL file template to match the at least one instruction set.

2. The PLC compiling system of claim 1, wherein the instruction set loading unit comprises an X86 instruction set module and an advanced RISC machines (ARM) instruction set module, wherein the at least one instruction set comprises an X86 instruction set stored in the X86 instruction set module and an ARM instruction set stored in the ARM instruction set module.

3. The PLC compiling system of claim 1, wherein the operating system loading unit comprises a Windows XP (WinXP) system module and a Windows CE (WinCE) system module; the at least one operating system comprises a WinXP system and a WinCE system; the at least one DLL file template comprises a WinXP DLL file template based on a WinXP system and stored in the WinXP system module, and a WinCE DLL file template based on a WinCE system and stored in the WinCE system module.

4. A programmable logic controller (PLC) compiling method, comprising:
loading a plurality of predetermined ladder diagrams;
loading a plurality of instruction sets;
compiling the plurality of predetermined ladder diagrams to a plurality of instructions based on the plurality of instruction sets;
loading a plurality of dynamic link library (DLL) file templates based on a plurality of operating systems; and
compiling the compiled plurality of instructions to a plurality of DLL files based on the plurality of DLL file templates to match the plurality of instruction sets.

5. The PLC compiling method of claim 4, wherein the plurality of instruction sets comprise an X86 instruction set and an advanced RISC machines (ARM) instruction set.

6. The PLC compiling method of claim 4, wherein the plurality of DLL file templates comprise a WinXP DLL file template based on a WinXP system and a WinCE DLL file template based on a WinCE system.
